(19) United States
(12) Patent Application Publication
(10) Pub. No.: US 2002/0170574 A1
(43) Pub. Date: Nov. 21, 2002

(54) Differential Cleaning for semiconductor wafers with copper circuitry

(75) Inventor: Justin M. Quarantello, Phoenix, AZ (US)

Correspondence Address: Laura J. Zeman, Snell & Wilmer LLP, One Arizona Center, 400 East Van Buren, Phoenix, AZ, 85004-2202, US

(73) Assignee: SpeedFam-IPEC Corporation

(21) Appl. No.: 09/862,657

(22) Filed: May 21, 2001

(51) Int. Cl. B08B 3/02

(52) U.S. Cl. 134/6; 134/33; 134/36

(57) ABSTRACT

The invention provides a method for differentially applying cleaning chemistries to a silicon wafer that has undergone a polishing process whether chemical mechanical polishing or polishing with a fixed abrasive material. In accordance with the invention, cleaning fluid with a specific chemistry designed for cleaning the front side of the wafer is applied to the front side; while different chemistry specifically selected for more effectively cleaning the rear side of the wafer is applied to that side. This application of different chemistries to the two sides of the wafer is referred to as “differential cleaning”.

### BACKGROUND OF THE INVENTION

1. Field of Invention

The invention relates to the fabrication of semiconductor chips, and more particularly to the cleaning of silicon wafers used in fabrication of these chips, after the wafers have been subjected to chemical mechanical polishing or other polishing.

2. Description of the Related Art

Semiconductor chips find increasing application in all aspects of modem life. Chips are now ubiquitous, and are found in consumer goods and in industrial capital equipment. Manufacturing processes for these chips require a virtually dust-free environment and stringent manufacturing specifications, in order to produce defect-free chips.

In general, during the manufacture of semiconductor chips a silicon wafer is subjected to a series of processes that create layered structures which form the circuitry of the semiconductor chips on one side surface of the wafer. Typically, these wafers are 8 inches (200 mm) or 12 inches (300 mm) in diameter. A variety of processes may be used to lay down the films or layers that make up the electrical circuit of the semiconductor. However, at periodic intervals, it is necessary to polish the wafer surface to either replanarize the surface for laying down additional films, or to remove portions of films selectively, or both. Typically, this polishing process is carried out through application of “chemical mechanical polishing” (CMP) on a machine that includes a wafer carrier for holding the wafer in position, typically through suction force applied to the back surface of the wafer, and a polishing platen to which is mounted a polishing pad. The pad and carrier are brought into relative motion, with the pad firmly pressed against the wafer front surface on which films have been formed. This results in polishing the wafer surface. Typically, a chemically active and abrasive slurry is added and flows into the interface between the pad and the wafer assisting in polishing and selective removal of a material from the wafer surface. In other applications, polishing may be carried out with a fixed abrasive pad which includes abrasive elements embedded in the pad. Typically, when a fixed abrasive pad is used a chemical slurry is not necessary.

After polishing, by whatever method, the silicon wafer surface may include fine particles of debris resulting from the polishing. The debris particles include fragments of layers removed from the wafer surface, and may also include abrasives from a chemical slurry if one was used, and abrasives from a polishing pad if a fixed abrasive pad was used during polishing.

In order to remove polishing debris from the polished wafer surface, the wafer is usually subjected to some form of post-polish cleaning. In certain instances, the wafer may be guided through a pinch point between a pair of cylindrical brush rollers with the application of water or other cleaning fluid to assist in brushing the wafer surface clean of polishing debris. Typically, the cleaning apparatus are designed to clean both sides of the wafer with a common cleaning liquid.

### SUMMARY OF THE INVENTION

This summary of the invention section is intended to introduce the reader to aspects of the invention and is not a complete description of the invention. Particular aspects of the invention are pointed out in other sections herein below and the invention is set forth in the appended claims, which alone demarcate its scope.

The invention provides methods for cleaning a workpiece, such as a silicon wafer including semiconductor circuitry on one side, that may have different contaminant types and concentrations on each side using a different cleaning fluid on each side of the wafer. The cleaning fluids having chemistry specifically selected for cleaning contaminants from each of the two sides of the workpiece while minimizing damage that a chemistry applied to one side may cause to the opposite side of the workpiece.

In one embodiment, a silicon wafer having semiconductor circuitry on a front side, has contaminants on the opposite side that may readily be removed with a first cleaning solution, but the first cleaning solution may etch or otherwise damage the front side of the wafer, and the semiconductor circuitry thereon. In accordance with the invention, two separate cleaning solutions are used. One cleaning solution is applied on the side containing semiconductor circuitry that has chemistry compatible with the circuitry, to minimize or avoid any potential damage to these circuits being fabricated. The opposite side of the wafer is treated with a cleaning solution suitable for removing metallic contaminants, such as copper contamination found in wafers treated with the damascene processes. In accordance with the invention, the carryover of this cleaning solution to the semiconductor device side of the wafer is minimized, and metallic contamination is more effectively removed from the rear side of the wafer. As result, potential migration of metallic contaminants from the rear side of the wafer to the semiconductor devices on the opposite side is minimized, or virtually completely eliminated. In addition, cleaner wafer rear sides reduce metrology and line cross-contamination especially in fabs where copper and non-copper processes are practiced. Further, in lithography, where line sizes are being reduced and depth of focus is an issue, particles may soon become a factor that affects depth of focus and hence the formation of the fine line details of micro-circuits being formed on the wafer. The invention potentially reduces these depth of focus issues by cleaning off these particles.

The cleaning method of the invention presents the possibility of increased yields of on-specification semiconductor chips from silicon wafers by reducing the potential for contaminants to migrate into the semiconductor devices during fabrication.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings which are schematic and not to scale, wherein:

FIG. 1 is a schematic diagram illustrating an embodiment of the invention utilizing a cleaning apparatus that includes a pair of brushes;

FIG. 2 is a schematic representation of an embodiment of the invention wherein the workpiece is rotated at high speed, while differential cleaning is applied; and

FIG. 3 is a bar graph representing concentrations of particular elements found on a rear side of a silicon wafer, after conventional cleaning fluid has been applied, and after treatment with the differential cleaning of the invention.

### DETAILED DESCRIPTION OF THE PREFERRED EMBODIMENTS

This section illustrates aspects of the invention, and points out certain preferred embodiments of these aspects. This section is not intended to be exhaustive, but rather to inform and teach the person of skill in the art who will come to appreciate more fully other aspects, equivalents, and possibilities presented by invention, and hence the scope of the invention as set forth in the claims, which alone limit its scope.

The invention provides a method for differentially applying cleaning chemistries to a silicon wafer that has undergone a polishing process whether chemical mechanical polishing or polishing with a fixed abrasive material. In accordance with the invention, cleaning fluid with a specific chemistry designed for cleaning the front side of the wafer is applied to the front side; while cleaning fluid with different chemistry specifically selected for more effectively cleaning the rear side of the wafer is applied to that side. This application of different chemistries to the two sides of the wafer is referred to as “differential cleaning” herein.

In this application, the term “front side” as applied to a wafer means the side on which semiconductors are being formed, also known as the “device side.” The opposite side is the “rear side.” Typically, the front side is in post polish condition (i.e. it has been polished by CMP or another process) and includes copper interconnects, tungsten plugs, STI trenches and other circuit elements. The rear side of the wafer includes silicon, silicon nitride, silicon oxide; polished or unpolished.

In accordance with the invention, it has been identified that wafer rear side contamination, in the form of metallic contaminants especially, is a significant issue that leads to possible yield loss of on-specification semiconductor chips from a wafer. It is theorized, without being bound, that contaminants migrate through silicon dioxide and silicon and effect the front or device side of the silicon wafer. This migration of contaminants, whether chemical polishing debris or other particulates, is potentially deleterious and may result in yield loss of semiconductor chips. In particular, the invention identifies metallic contaminants, for example copper contaminants more commonly found in wafers subjected to the newer copper-based dual damascene-type processes for fabricating semiconductor chips, as being particularly harmful.

The invention has also identified that certain chemistries, while suitable for cleaning wafer rear sides, may adversely react with metallic components, such as copper interconnects, or may not effectively remove particles from these surfaces. Likewise, other chemistries suitable for cleaning copper, may not be capable of removing contaminants from the wafer rear sides with an exposure time commensurate with the throughput requirements of a post CMP cleaning.

In accordance with the invention, there is now provided a method for applying cleaning fluid of a specific chemistry to the front side of the wafer, and a different chemistry to the rear side of the wafer, that is specifically selective for removing metallic elements, such as copper, and that might be deleterious if applied to the front side of the wafer. For example, the chemistry applied to the rear side of the wafer may include hydrofluoric acid, or other active fluorinated compounds that react with metallic elements, to remove metallic contaminants on the rear of the wafer before these can diffuse or migrate to the front side of the wafer where they might have an adverse effect on semiconductor device yield or performance.

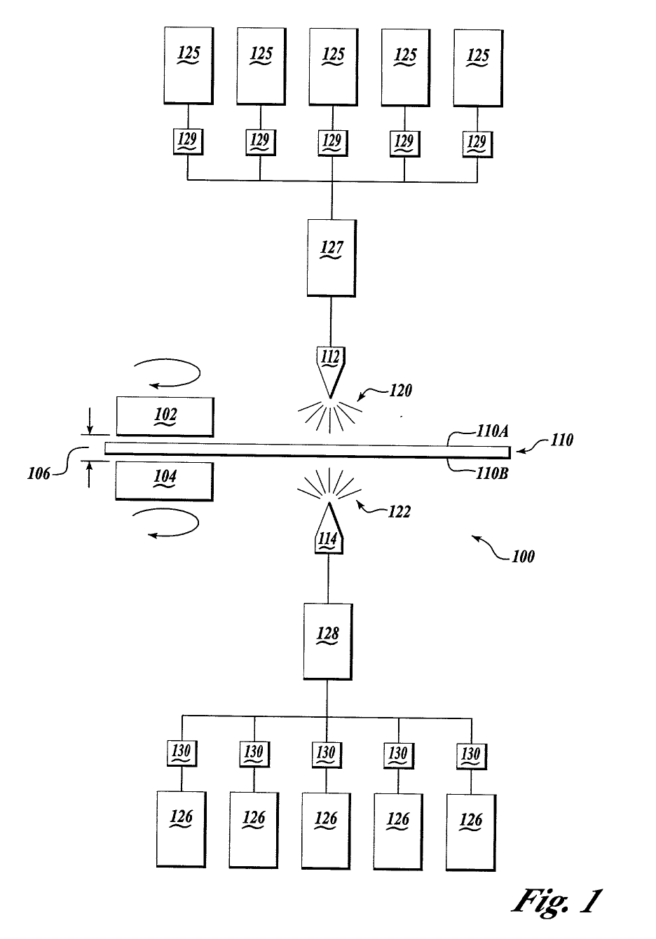

While there are a variety of ways implementing the invention, one method of implementing the invention is illustrated schematically in FIG. 1. The cleaning device 100 of FIG. 1 includes an upper brush 102 and a lower brush 104 with an intervening space 106 between the two sized for receiving a semiconductor wafer 110. While FIG. 1 shows pancake brushes, roller, or other brush types may also be used. Further, the cleaning apparatus is supplied with a first nozzle 112 for supplying cleaning fluid 120 to the upper surface 110A of the wafer 110 and upper brush 102, and a second lower nozzle 114 for supplying cleaning fluid 122 to the rear side 110B of the wafer 110 and the lower brush 104. Clearly, in some apparatus, the cleaning fluids may be supplied through the brushes themselves. The first nozzle 112 is in fluid communication with several reservoirs 125, each of which contains a component of the cleaning fluid 120. Thus, cleaning fluid 120 is metered from each of the reservoirs 125, through a pump 127 and measuring devices 129, such as a rotameter and control valve, into the first fluid nozzle. Likewise, the second or lower fluid nozzle 114 is also in fluid communication with several reservoirs 126 from which components of its cleaning fluid can be withdrawn, through pumps 128 and controlled through control devices 130 such as measuring rotameters and valves. Accordingly, the apparatus of FIG. 1 permits customizing of the composition of the cleaning fluid supplied to each of the two nozzles 112, 114.

During operation, a standard cleaning fluid or de-ionized water can be supplied through nozzle 112 to the device side of the wafer. This fluid, together with the action of the upper brush 102, should sufficiently clean the upper surface 110A of the wafer 110. On the other hand, a second cleaning fluid, containing hydrofluoric acid and or other fluorinated compounds that are active for metallic elements, may be supplied through nozzle 114 to the rear side 110B of the wafer 110 and the lower brush 104. By ensuring that cleaning fluid from the upper nozzle 112 flows over the wafer 110 and drains downward, the risk that the second cleaning fluid containing fluorine ions will migrate to the upper surface 110A is significantly reduced thereby reducing the risk of damage to semiconductor devices.

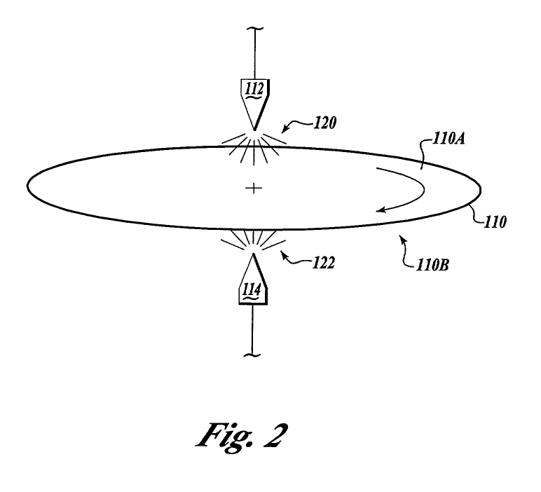

In other embodiments, the wafer is rotated at relatively high speed, generating centrifugal force on any liquid adhering to its surface, so that the water is spun off the surface, as shown schematically in end view FIG. 2. In accordance with the invention, the fluorine ion containing cleaning fluid 122 is applied to the rear surface 110B of the wafer 110 while the wafer is spinning and the sheer forces generated by fluid flowing off the wafer together with chemical reaction with the contaminants results in cleaning of the rear of the wafer. At the same time, contamination of the front side 110A of the wafer 110 with fluorine-containing fluid is minimized due to the centrifugal action of the spinning wafer. The front side 110A of the wafer 110 may at the same time be subjected to a different cleaning fluid 120, more compatible with the semiconductor devices and other exposed surfaces of the device side of the wafer.

In accordance with the invention, the chemistry of the cleaning fluid for use on the rear side of the wafer to remove metallic elements includes reactive halogen ions, in particular fluorine ions, although chlorine, bromine and iodine ions are also useful. Indeed, with respect to removal of metallic or minute particles, such as copper ions, the cleaning solution may also include acids that are reactive with metal, namely hydrogen fluoride, nitric acid, sulfuric acid, hydrochloric acid, hydrogen iodide, hydrogen bromide, and the like. Indeed, the only limitation is that the concentration of the reactive ions present in the cleaning fluid should be sufficient to remove the metallic elements, without causing significant damage through etching of the silicon wafer itself.

In accordance with the invention, the concentration of reactive ions in the cleaning fluid for the rear side of the wafer is dependent on the relative reactivity of the ions with the metal sought to be removed and silicon. In the case of fluorine ions, derived from hydrofluoric acid or other fluorine compounds, the concentration of fluorine ions should be in the range from about 0.01 to about 2.5M, and preferably in the range from about 0.1 to about 0.5M. The cleaning fluid may be deionized water and may contain at least any of the following chemicals and/or active ions: ammonium hydroxide, tetramethylammonium hydroxide, tetraethylammonium hydroxide, benzotriazole, gallic acid, oxalic acid, formic acid, ascorbic acid, citric acid, malic acid, gluconic acid, malonic acid, succinic acid, benzoic acid, propionic acid, and the like.

Typically, cleaning is carried out at room temperature, approximately in the range about 18 to about 25 degrees Centigrade although higher temperatures may be applied consistent with minimizing wafer damage. Ordinarily, cleaning is not carried out under greater than atmospheric pressure in the surrounding environment. However, it should be understood that when brushes or jets of cleaning fluid are utilized in the invention, contacted regions of the surface of the semiconductor wafer will be subjected to localized pressure.

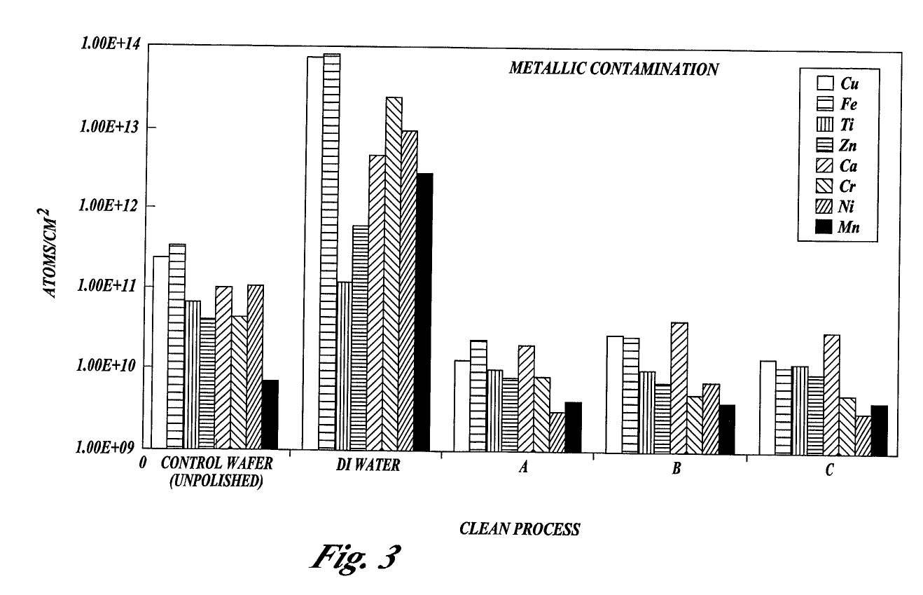

The effectiveness of the present invention utilizing differential cleaning of semiconductor wafers is readily apparent from FIG. 3. FIG. 3 shows graphically the remaining concentrations of metallic atoms on the rear side of a wafer that has not been polished (control wafer); and of a wafer that has been polished and cleaned with deionized water (DI), and three examples of wafers that after polishing underwent cleaning with three different cleaning fluids of the invention A, B, and C.

The results show a significant decrease in concentration of each of the metals using fluids of the invention, and especially a significant decrease in copper concentration, as compared to conventional cleaning. This is important since the trend in the manufacture of semiconductor chips is to use copper instead of aluminum for several reasons, including its superior conductive properties.

The foregoing description provides an enabling disclosure of the invention, which is not limited by the description but only by the scope of the appended claims. All those other aspects of the invention that will become apparent to a person of skill in the art, who has read the foregoing, are within the scope of the invention and of the claims herebelow.

1. A method of cleaning a workpiece, comprising:
selecting a workpiece comprising a first side and a second side, the first side of the workpiece having thereon a contaminant removable with a first cleaning solution, the second side of the workpiece subject to chemical attack by the first cleaning solution;
applying the first cleaning solution to the first side while minimizing carryover of the first cleaning solution to the second side; and
applying a second cleaning solution to the second side.

2. The method of claim 1, wherein the workpiece is a semiconductor wafer comprising semiconductor devices in the second side of the wafer.

3. The method of claim 1, wherein the first cleaning solution comprises ions derived from the group of chemicals consisting of hydrogen fluoride, nitric acid, sulfuric acid, hydrochloric acid, hydrogen bromide, hydrogen iodide, ammonium hydroxide, tetramethylammonium hydroxide, tetraethylammonium hydroxide, benzotriazole, gallic acid, oxalic acid, formic acid, ascorbic acid, citric acid, malic acid, gluconic acid, malonic acid, succinic acid, benzoic acid, and propionic acid.

4. The method of claim 1, wherein the second cleaning solution comprises de-ionized water.

5. The method of claim 1, further comprising restraining the workpiece in a horizontal position while applying the first and second cleaning solutions.

6. The method of claim 1, further comprising restraining the workpiece in a verticle position, while applying the first and second cleaning solutions.

7. The method of claim 1, further comprising rotating the workpiece while applying the first cleaning solution and applying the second cleaning solution, the rotating at a sufficiently high speed to generate centrifugal forces that cause liquid to flow outward of the first and second sides.

8. The method of claim 1, further comprising brushing the first side of the workpiece with a first brush, while applying the first cleaning solution.

9. The method of claim 8, further comprising brushing the second side of the workpiece with a second brush while applying the second cleaning solution.

10. The method of claim 1, further comprising brushing the second side of the workpiece with a brush, while applying the second cleaning solution.

11. A method of cleaning a wafer comprising:
selecting a wafer comprising a first side comprising semiconductor devices and opposite second side, the second side having thereon a contaminant removable with a cleaning solution, the semiconductors of the workpiece subject to chemical attack by the first cleaning solution;
applying the cleaning solution to the second side while minimizing carryover of the cleaning solution to the second side; and
applying another cleaning solution to the first side.

12. The method of claim 11, wherein the cleaning solution comprises ions derived from the group of chemicals consisting of hydrogen fluoride, nitric acid, sulfuric acid, hydrochloric acid, hydrogen bromide, hydrogen iodide, ammonium hydroxide, tetramethylammonium hydroxide, tetraethylammonium hydroxide, benzotriazole, gallic acid, oxalic acid, formic acid, ascorbic acid, citric acid, malic acid, gluconic acid, malonic acid, succinic acid, benzoic acid, and propionic acid.

13. The method of claim 11, wherein the second cleaning solution comprises de-ionized water.

14. The method of claim 11, further comprising restraining the workpiece in a horizontal position while applying the cleaning solutions.

15. The method of claim 11, further comprising restraining the workpiece in a verticle position, while applying the cleaning solutions.

16. The method of claim 11, further comprising rotating the workpiece while applying the cleaning solution and applying another cleaning solution, the rotating at a sufficiently high speed to generate centrifugal forces that cause liquid to flow outward off the first and second sides.

17. The method of claim 11, further comprising brushing the side of the workpiece with a brush, while applying the cleaning solution.

18. The method of claim 11, further comprising brushing the first side of the workpiece with another brush while applying another cleaning solution.

19. A method of cleaning a wafer comprising;
selecting a wafer comprising a first side and a second side, the first side of the wafer having thereon a contaminant removable with a first cleaning solution, the second side of the wafer comprising semiconductor circuitry, the semiconductor circuitry subject to chemical attack by the first cleaning solution;
applying the first cleaning solution to the first side of the wafer, the first cleaning solution comprising active fluorine ions in a concentration ranging from about 0.01 to about 2.5M; and
applying a second cleaning solution to the second side of the wafer.

20. The method of claim 19, wherein the second cleaning solution comprises de-ionized water.

21. The method of claim 19, further comprising restraining the workpiece in a horizontal position while applying the first and second cleaning solutions.

22. The method of claim 19, further comprising restraining the workpiece in a verticle position, while applying the first and second cleaning solutions.

23. The method of claim 19, further comprising rotating the workpiece while applying the first cleaning solution and applying the second cleaning solution, the rotating at a sufficiently high speed to generate centrifugal forces that cause liquid to flow outward of the first and second sides.

24. The method of claim 19, further comprising brushing the first side of the workpiece with a first brush, while applying the first cleaning solution.

25. The method of claim 19, further comprising brushing the second side of the workpiece with a second brush while applying the second cleaning solution.
